(19) United States
(12) Patent Application Publication
(10) Pub. No.: US 2019/0094125 A1
(43) Pub. Date: Mar. 28, 2019

(54) APPARATUS AND METHOD FOR EVALUATING LUBRICANT OIL VARNISH

(71) Applicant: Chevron U.S.A. Inc., San Ramon, CA (US)

(72) Inventors: Zhen Zhou, Fairfield, CA (US); Elizabeth Montalvo, El Cerrito, CA (US)

(21) Appl. No.: 16/142,919

(22) Filed: Sep. 26, 2018

Related U.S. Application Data
(60) Provisional application No. 62/563,144, filed on Sep. 26, 2017.

(51) Int. Cl. G01N 17/04; G01N 17/00

(52) U.S. Cl. CPC G01N 17/043; G01N 17/002

(57) ABSTRACT

A method and apparatus for generating lube oil varnish samples and testing them under flow conditions is set forth herein. The method and apparatus are also used for the evaluation of the efficiency of varnish cleaners.

### BACKGROUND

Varnish as lacquer-like deposit, is commonly observed in a lubrication system, e.g. on bearing surface or in an oil reservoir, which is typically not easy to be removed from the metal surface by simply wiping. Varnish is formed as hydrocarbon base fluids degrade through oxidation. Oxidation is accelerated by exposure to increased temperature, mechanical stresses, ultraviolet light, entrained air, electrostatic discharge, and wear materials (metals) found in typical machines (Rudnick, L. R., (2009), Korcek, S., and Jensen, R. K. (1976)). Varnish is first formed as soluble primary oxidation products, such as acids, water, and alcohols, follow condensation and polymerization reactions to form insoluble products (Fox, M. F. (2010)). These products are polar, causing varnish to adsorb on metal surfaces where further agglomeration thickens the varnish (Sasaki, A. (2014)).

Lubricant varnish issues in industrial equipment have been noticed and investigated for a long time from different aspects. Varnish may fill the tight clearances between the valve and bore in hydraulic circuits, causing erratic valve operation and in some cases fully seized valves (Migdal, C. A., Wardlow, A. B., and Ameye, J. L. (2008)). Varnish contributes to decreased efficiency, increased wear and corrosion, impaired oil cooler performance, and inadequate hydrodynamic lubrication. Journal bearings that experience varnish buildup have increased shear rates, increased operational temperatures, and, in extreme cases, bearing failure (Atherton, B. (2007)). A sticking inlet guide vane valve of large-frame gas turbines, such as those used in the power generation industry, can produce a fail-to-start, or a shutdown event (Kumar, N., Besuner, P., Lefton, S., Agan, D., and Hilleman, D. (2012)).

Varnish removal can be performed using chemical flushing compounds. Flushing involves circulation of fluid through the lubrication system or a component to remove varnish or other contaminants. ASTM D6439 provides guidelines for flushing turbine lubrication systems (ASTM D6439-11 (2017)). However, till now no reliable, standardized methods have been reported to investigate removal of varnish film by fluids with varnish cleaning function at desired temperature and oil flow conditions, and to characterize removal amounts and rates.

The key difficulties of developing such methods are: (1) generate a varnish film suitable for testing at bench scale within acceptable time frame and (2) design a specific testing unit to circulate oil at various temperature and flow conditions on the top of the varnish film. Standardized test methods for varnish removal by chemical flushing could ultimately enable direct comparison of the effectiveness of chemical compounds, as well as guidance for selecting a compound for a given application.

### SUMMARY OF THE INVENTION

An embodiment of the invention is a method for generating lube oil varnish samples and testing them under various temperature and flow conditions. A further embodiment of this method is the testing and evaluation of the efficacy of different fluids for varnish removal.

Another embodiment of the invention is an apparatus containing a varnish coupon for evaluating lubricant varnish samples under flow conditions. An additional embodiment is the operation of the apparatus containing the varnish sample.

A further embodiment is a varnish coupon composition.

### BRIEF DESCRIPTION OF THE DRAWINGS

FIG. 1 is a diagram of the components of the varnish removal testing apparatus.

FIG. 2 is a schematic of the test cell area comprising the varnish coupon.

FIG. 3 is a plot of the percent varnish mass removed during the 120-min tests on Fluid A and Fluid B. Insets show photos of the coupons after each of the tests.

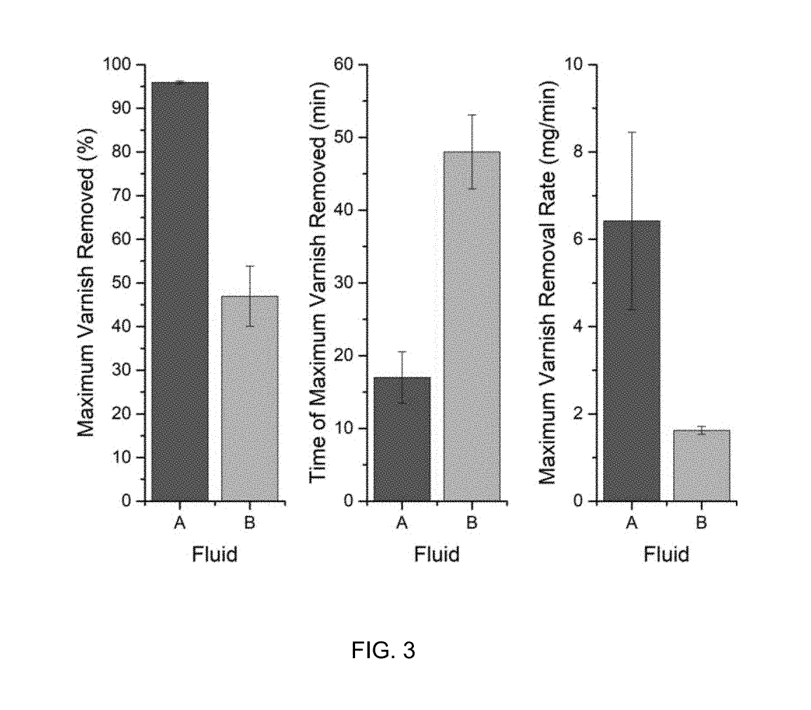

FIG. 4 is a plot of a comparison of Fluids A and B in terms of three varnish removal performance metrics. Left: maximum percent varnish removed. Center: time required to achieve steady state varnish removal. Right: maximum varnish removal rate.

### DESCRIPTION OF THE INVENTION

Herein is described an apparatus and method for evaluating lubricant varnish samples under temperature and flow conditions.

“Standardized” as used herein is predetermined composition and dimensions of a controllable substrate wherein the composition is characterized through analytical means including but not limited to Fourier-transform infrared spectroscopy (FTIR). The substrate can be any material upon which varnish formation may occur, including but not limited to metals such as copper and steel, rubber, glass, plastics or combinations thereof that are heat resistant.

“Coupon” as used herein is a layered composition comprising a base substrate layer and a varnish layer on the top.

“Varnish” as used herein is a deposit layer formed by lubricant degeneration in the presence or absence of environmental and chemical factors, including but not limited to oxygen, heat, water, particulate solids, metals and chemicals. The terms “artificial varnish” are also consistent with the term varnish.

“Lubricant blend” as used herein is a base fluid/oil with combination of specific additives including but not limited to rust inhibitors, antioxidants, anti-wear.

A method and apparatus are set forth herein to quantify varnish removal using chemical cleaners. The test apparatus has been designed to allow control of flow rates and temperatures across a coupon comprising a sample of artificial varnish. The artificial varnish is produced using common oxidative mechanisms and is characterized to ensure the material accurately simulates varnish produced within an environment conducive to varnish production. The varnish is then subjected to chemical flushes at controlled flow rates and temperatures. Testing metrics include mass loss and time-lapse video data, where the latter is analyzed quantitatively to determine performance parameters, including the maximum rate of varnish removal. Full characterization of varnish removal is determined via (1) maximum varnish removed, (2) time at which the maximum varnish has been removed, and (3) maximum rate of varnish removal. Mass loss of varnish film is determined by difference of coupon weight before and after varnish removal or intervals thereof, and by correlating the difference of coupon color rating using photographic analysis.

In one aspect of the present disclosure, a standardized coupon is generated with defined composition and dimensions of varnish film, herein described as a varnish coupon:
(a) Aging a specific lubricant blend through thermal aging tests such as ASTM D7873, D943, D4310, D2272, D4636, D2691, D2070, D2893, D5763, D2893, DIN 51554, DIN 51352, IP 306, IP 140, IP 280, FTM 791A-3462, JIS K-2514 tests and modified versions of these standard tests to generate various types of sludge. The time of sludge formation can be controlled with specific lubricant blends. The sludge can be also collected by scraping deposits from the surface of metal parts and filters in industrial equipment. Concentration of the sludge is also achieved through filtration.
(b) The soft, gel-like sludge is directly pasted onto a substrate; the powdery sludge is cold or hot pressed by a hydraulic press onto a substrate, with or without a bonding material.
(c) Post heat-treatment of the film is conducted in an oven at temperature of 40° C. or higher and with certain time frame to make standardized varnish coupons.

An embodiment of the present disclosure is a fluid circulation and varnish removal test system comprising a reservoir, motor, pump, flowmeters, ball valves, relief valves, pressure gauge, test cell, in line pressure filter and heater. The test cell comprises an accessible housing with input and output fluid lines for placement of a removeable varnish coupon. The placement of the coupon in the test cell is such that the top of the coupon, where the varnish resides, is flush with the bottom of the incoming pipe wall. This provides a continuous no-slip condition from the pipe wall to the coupon, thereby exposing only the varnish to the fluid flow. This simulates many environments where varnish is formed on the no-slip boundary conditions of machinery. The lid of the test cell may comprise a vapor-polished polycarbonate, allowing a camera to be positioned above the coupon for recording. Each test is preceded by flushing the system with the base stock to remove any remaining fluid from the previous test. First, the system is drained, and air is injected into the system for 5 min to remove previous test fluid. Then, the system is flushed with 5 gal of base fluid for 20 min, for a total of 90 gal of flow. Finally, a new test fluid is added to the system and circulated through both the main and bypass lines. The system is initially run without the coupon until the temperature reaches steady state. Then the flow is stopped temporarily, and a prepared coupon is inserted into the test cell. The camera lighting is turned on and photographic recording begins. The system is turned back on and the desired duration of testing is performed. During the test, images are captured using a 12.0-MP resolution camera set to take a photograph every 10 s. The placement of the camera is fixed so that the position of the varnish is the same for all tests. Upon completion of the test, the coupon is removed from the test cell and dried in heptane to remove any fluid from the sample prior to weighing. An initial post-test mass recording is done and 24 hr later another is performed to ensure no further change occurred due to evaporating heptane. The difference between the pre-test and post-test mass is identified as mass loss, one of the metrics used to characterize varnish removal.

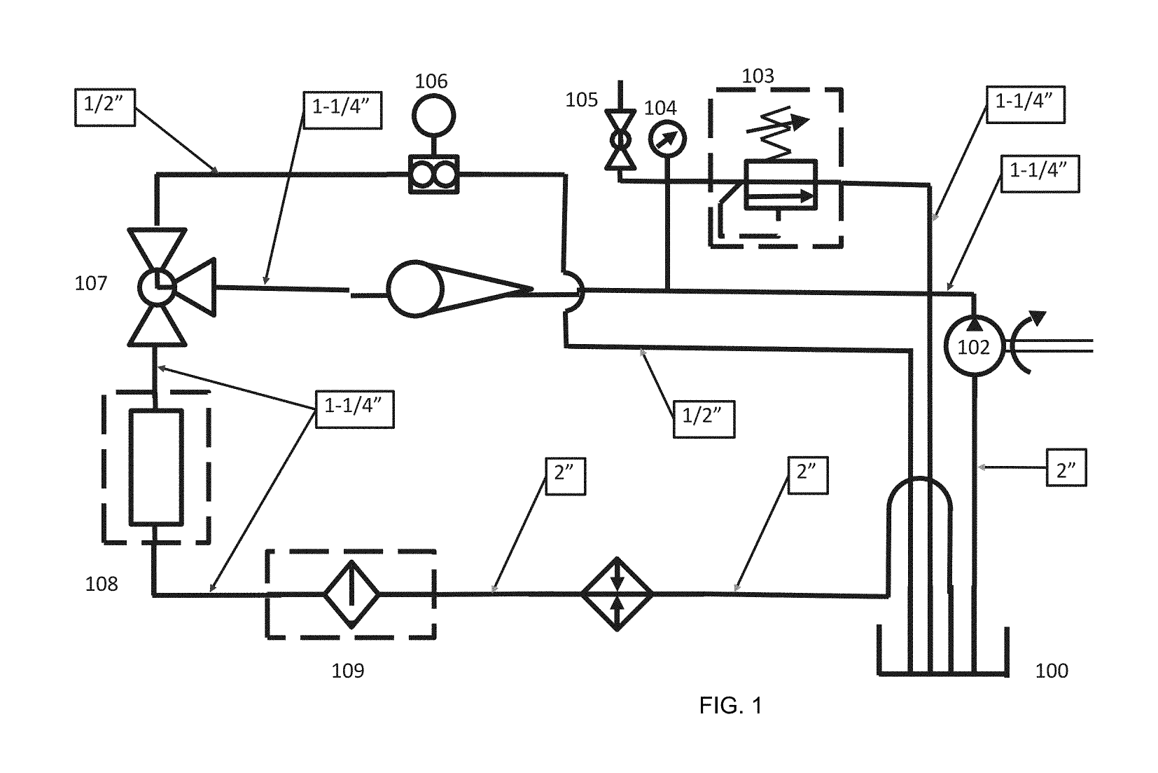

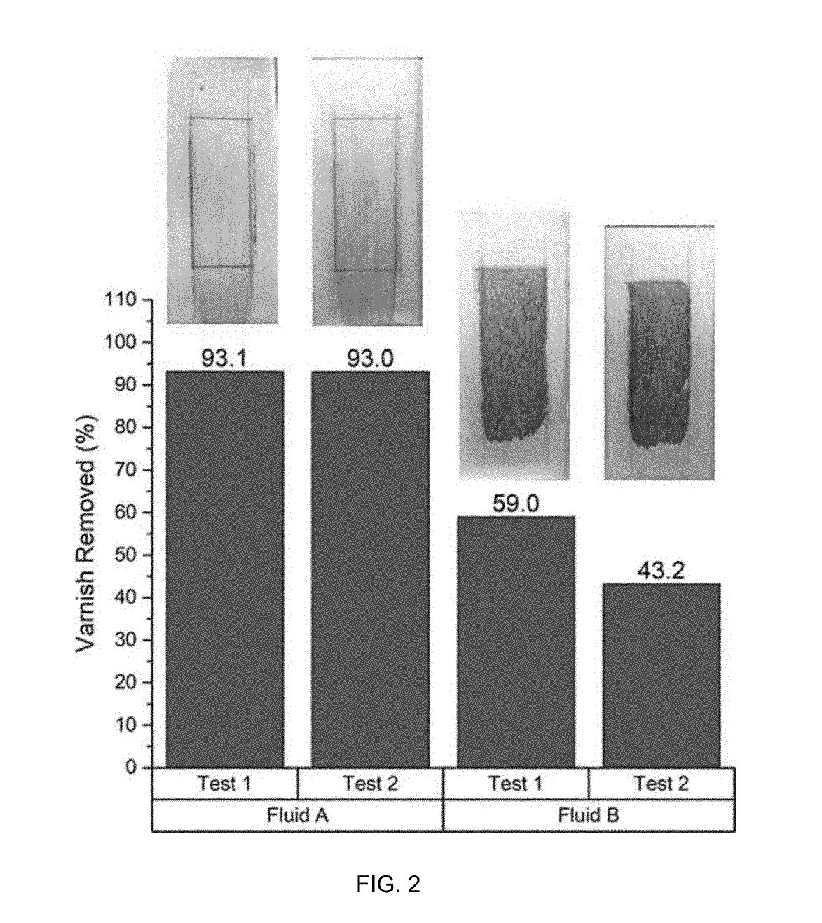

Another embodiment of the present disclosure is a method of testing a varnish coupon within the oil circulation system: A specific testing cell (FIG. 2) and a fluid circulation system (FIG. 1) is designed to investigate the varnish coupons under different temperatures (r.t. to 150° C.), time, fluid flow rates (0.1 GPM to 100 GPM) and patterns (Reynolds number range of 1-100000, preferably 13-20165 in Table 1). The properties of varnish film can be measured before and after the circulation test. Evaluation of varnish coupons under flow conditions comprises testing known to one of skill in the art including but not limited to analytical and spectroscopic analysis such as visual and microscopic analysis, weight, thickness and adhesion strength measurements.

Correspondingly, a further embodiment of the invention is that the efficiency of different fluids for varnish removal may be assessed using the apparatus and method described herein.

TABLE 1
Reynolds number based on temperature*

| | temp | | |
|---|---|---|---|
| Re | 40° C. | 70° C. | 90° C. |
| (Re) min flow | 13 | 23 | 45 |
| (Re) max flow | 5830 | 10159 | 20165 |

*Flow rate: 0.1-48 gallons per minute (gpm); Temperature: 25-120° C.; Testing time: Operator specified; Flow regime: laminar to turbulent; Oil viscosities: ISO VG 2-ISO VG 100.

Other features and aspects of this disclosure will become apparent from the following description and the accompanying drawings.

Referring to FIG. 1 and FIG. 2 for an embodiment of the fluid circulation and varnish removal system, the circulation system 99 includes a reservoir with baffle 100, a conduit coupled to the hydraulic pump 102, motor for powering the hydraulic pump 101, relief valve 103, pressure gauge 104, ball valve 105, positive displacement flow meter 106, three-way ball valve 107, test cell 108, in-line pressure filter 109, heater 110, and flow meter 111.

An embodiment of the present disclosure for operation of the system as represented by FIG. 1: a blank coupon is housed in the test cell 108, the 3 way ball valve 107 is set to test cell position, turn on power supply to inverter, turn on motor 101 with frequency set to 20 Hz, check to make sure reservoir 100 baffle is completely covered with fluid, check to make sure pressure gauge 104 reads less than 120 psi, set heater 110 to desired temperature, slowly turn 3 way ball valve 107 to allow a small amount (2 gpm) of oil through positive displacement flow meter 106, wait for system to reach desired temperature setting, when system reaches desired temperature turn motor 101 off, remove test cell 108 lid, remove blank coupon and replace with desired varnish coupon 112, re-install test cell lid, turn 3 way ball valve 107 to full test cell position, turn on motor 101 and allow 10 seconds to pass to purge air from test cell and return lines, turn 3 way ball valve 107 to allow full flow through positive displacement flow meter 106, adjust frequency of inverter to desired flow parameters (gpm), turn 3 way ball valve 107 to allow desired flow rate (gpm) to pass over coupon 112, when desired time is up, turn off motor 101, and remove coupon 112 for inspection. Inspection includes but is not limited to weight, thickness, area of varnish film, and photographic analysis to provide color rating for varnish film.

Another embodiment of the present disclosure is a method of evaluating the varnish coupon in a container containing a fluid under stirring/mechanical mixing and heating conditions: standardized varnish coupons are immersed in a glass beaker with a certain amount of testing fluid (FIG. 2). After stirring at various temperatures (r.t. to 150° C.), stirring speeds (1-10000 rpm) and time, the varnish coupon is removed, cleaned and physical properties including weight, thickness and area of varnish film were measured.

### EXAMPLE

The test system is demonstrated with two fluids, Fluid A and Fluid B, both of which are known to have varnish removal capabilities. Both fluids are commercial cleaners blended at the same weight percentage with a 46 cSt (at 40° C.) base oil. The chemical components of these commercial cleaners are unknown. However, the flash point of the commercial cleaner in Fluid A (<100° C.) is much lower than that of the commercial cleaner in Fluid B (>200° C.), which indicates higher light solvent content in Fluid A.

All tests are conducted at a temperature of 90° C., a flow rate of 4.5 GPM, and a duration of 120 min. With a flow rate of 4.5 GPM, an average velocity of 10.12 ft/s (3.08 m/s) is created within the test cell. The viscosities of the two fluids tested are 17.27 and 12.82 cSt at 90° C., which correspond to Reynolds numbers in the high laminar flow regime (ReA=1,442 and ReB=1,944). These conditions are selected to approximate lubrication conditions in a gas turbine engine, as well as to optimize the test in terms of sufficient varnish removal with a minimum test time. Two tests are run for each fluid under these conditions.

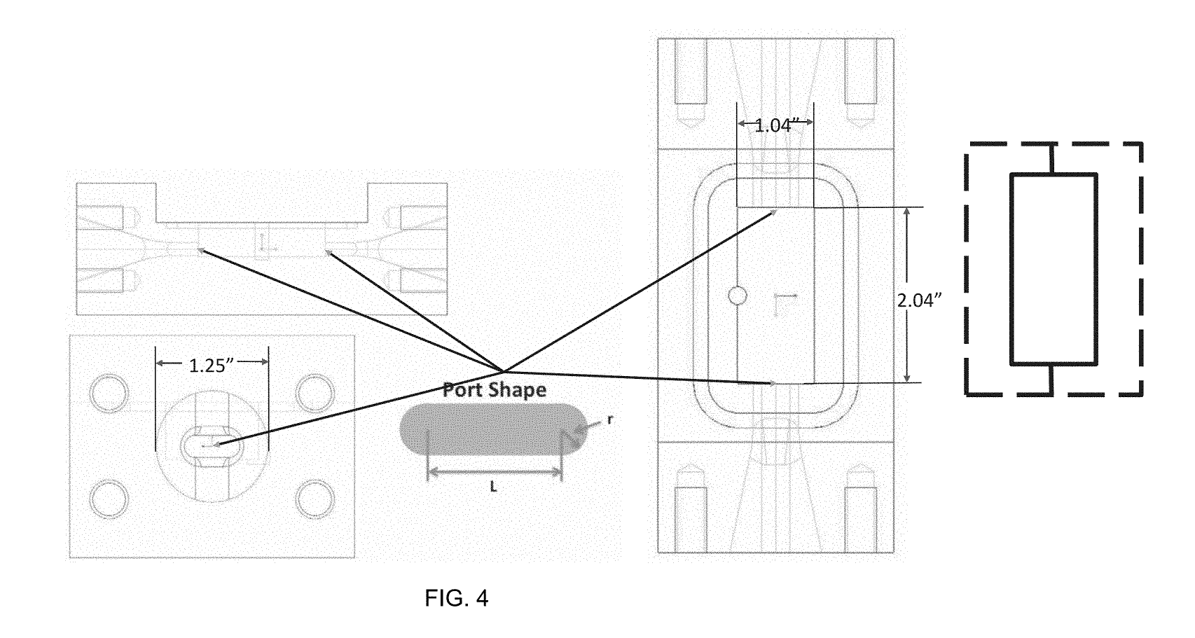

Mass loss results for the two tests performed on each fluid are shown in FIG. 4. There is a significant difference between the total mass removed by Fluid A and Fluid B during the 120-min test. On average, Fluid A removed 95.9% of the varnish while Fluid B removed 46.9%. The error in the two measurements is 1% for Fluid A and 34% for Fluid B. However, despite the relatively large error for Fluid B, the difference between the two fluids is statistically significant; that is, the minimum removed by Fluid A (95.4%) is much greater than the maximum removed by Fluid B (56.7%).

Using the three characterization parameters just mentioned, a direct comparison between Fluid A and Fluid B can be made, as shown in FIG. 5. In all cases, the parameters are averages from the two tests performed on each fluid. First, Fluid A removes substantially more varnish from the coupon than did Fluid B (95.9% vs. 46.9%). The time required to reach steady state varnish removal is also shorter for Fluid A than Fluid B (17 min vs. 48 min). Finally, Fluid A has a much higher maximum varnish removal rate than Fluid B (6.42 mg/min vs. 1.62 mg/min). Taken together, the comparison of these parameters shows that Fluid A is a much more aggressive chemical compound than Fluid B, removing twice as much varnish in half of the time.

1. A process for making a varnish composition comprising:
(a) Aging a specific lubricant blend through thermal aging tests consisting of ASTM D7873, D943, D4310, D2272, D4636, D2691, D2070, D2893, D5763, D2893, DIN 51554, DIN 51352, IP 306, IP 140, IP 280, FTM 791A-3462, JIS K-2514 tests and modified versions of these standard tests to generate various types of sludge in a gel or powder form,
(b) The soft, gel-sludge is directly pasted onto a substrate; the powdery sludge is cold or hot pressed by a hydraulic press onto a substrate, with or without a bonding material,
(c) Post heat-treatment of the resultant composition of (b) is conducted in an oven at chosen temperature and with certain time frame to make standardized varnish coupons.

2. A varnish coupon composition produced from step (c) of claim 1.

3. A fluid circulation apparatus for varnish removal testing comprising a reservoir with baffle, a conduit coupled to a hydraulic pump, motor for powering the hydraulic pump, pressure relief valve, pressure gauge, positive displacement flow meter, three-way ball valve, test cell containing a varnish coupon, in-line pressure filter, heater, and variable area flow meter.

4. A method for testing the removal of varnish comprising placing a varnish coupon in the fluid circulation apparatus of claim 3, circulating fluid for a desired time, removing the varnish coupon from the test cell and evaluating the physical properties of the varnish.

5. A method for testing the removal of varnish comprising placing a varnish coupon in a fluid filled container possessing a stirrer or mechanical mixer that induces fluid circulation, circulating the fluid around the varnish sample for a desired time, removing the varnish coupon, evaluating the physical properties of the varnish.

6. The method of claim 5 wherein the physical properties comprises weight, thickness, area of varnish film, and color rating.
